(19) United States
(12) Patent Application Publication
(10) Pub. No.: US 2003/0085238 A1
(43) Pub. Date: May 8, 2003

(54) Apparatus for dosing liquid gas into a multipane gas unit

(76) Inventor: Bradley A. Segro, Fairport Harbor, OH (US)

Correspondence Address: PEARNE & GORDON LLP, 526 SUPERIOR AVENUE EAST, SUITE 1200, CLEVELAND, OH, 44114-1484, US

(21) Appl. No.: 10/254,297

(22) Filed: Sep. 25, 2002

Related U.S. Application Data
(60) Provisional application No. 60/333,024, filed on Nov. 6, 2001.

(51) Int. Cl. B67D 5/00

(52) U.S. Cl. 222/3

(57) ABSTRACT

An apparatus that includes a liquid dosing unit for introducing a liquefied gas into a volume of a multipane glass unit, which glass unit is defined by one or more dimensional parameters. An apparatus further including one or more measuring devices that measure the dimensional parameters of the multipane glass unit.

### CROSS REFERENCE TO RELATED APPLICATIONS

This application claims the benefit of U.S. provisional application No. 60/333,024, filed Nov. 6, 2001.

### FIELD OF THE INVENTION

The present invention relates to an apparatus for dosing liquid gas and more particularly relates to an apparatus for dosing liquid gas into multipane glass units.

### DESCRIPTION OF THE RELATED ART

It is well known to utilize multipane glass units for windows and the like. The use of such units often provides various benefits, such as improved energy efficiency for buildings and any other structure incorporating such units. Such multipane glass units have at least two panes of glass that are spaced apart from each other utilizing a spacer that may take the form of an adhesive and/or other material that is also used to seal the edges of the glass panes together.

An interior space thus defined between the panes of glass is typically filled with a gas. The gas may have any desirable property. For example, the gas may have low thermal conductance, and/or may absorb certain portions of the light spectrum, and/or is generally chemically inert. Examples of such gasses include gasses from the noble gas family and the fluorocarbon gas family. Specific examples of such gasses include argon, krypton, xenon, nitrogen, etc., and mixtures thereof.

During assembly of a glass unit, the gas that is to be inserted and sealed between the panes is manually introduced through a small gap or hole in the sealing/spacing material. Typically, the gas is heavier than air. Accordingly, if the air is permitted to escape upwardly, the introduced gas will displace the air up and out, and the gas will slowly fill the entire space between the glass panes. This is somewhat of a time-consuming process in that the air must be permitted to be displaced.

### BRIEF SUMMARY OF THE INVENTION

In accordance with one aspect, the present invention provides an apparatus that includes a liquid dosing unit for introducing liquefied gas into a multipane glass unit.

In accordance with another aspect, the present invention provides a liquid dosing unit for introducing liquefied gas into a multipane glass unit, which liquid dosing unit further includes one or more measuring devices for measuring the dimensional parameters of the multipane glass unit.

### BRIEF DESCRIPTION OF THE DRAWINGS

FIG. 1 is a perspective illustration of an example apparatus for providing a liquid dosage of gas to a multipaned glass unit in accordance with the present invention;

FIG. 2 is a prospective illustration showing the introduction of the liquefied gas stream into the glass unit; and

FIGS. 3a and 3b are a flowchart illustrating an example process in accordance with the present invention; the example process begins on FIG. 3a, and continues and ends on FIG. 3b.

### DESCRIPTION OF EXAMPLE EMBODIMENTS OF THE INVENTION

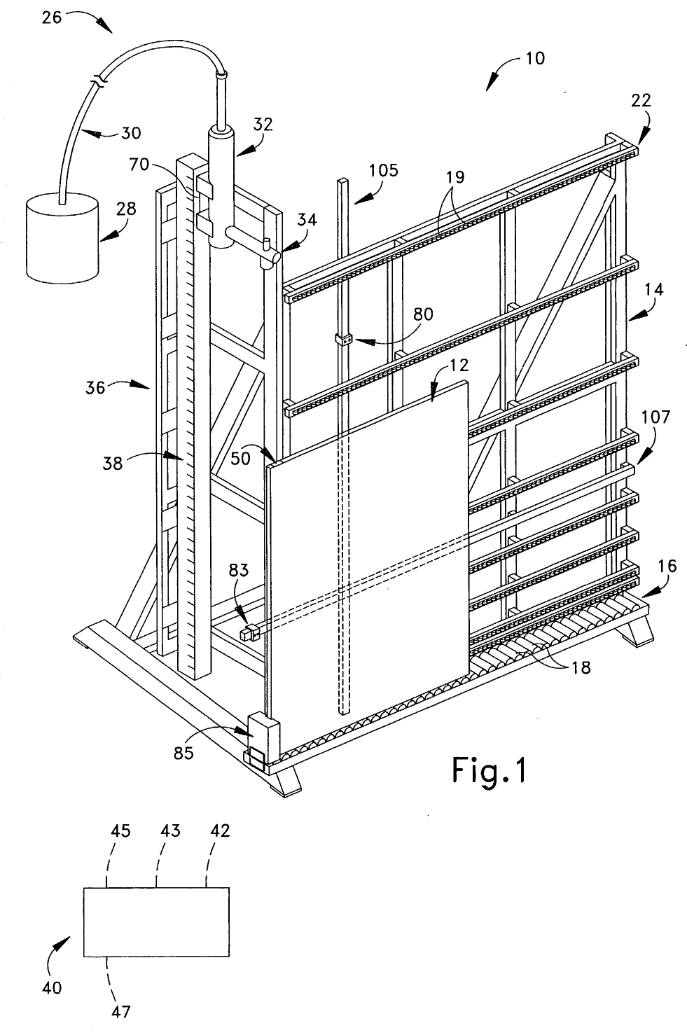

One example of an apparatus 10 used to dose liquefied gas into a volume 52 between glass panes of a multipane glass unit 12 is shown in FIG. 1. The apparatus 10 may be one of a plurality of devices used to dose liquefied gas into the glass unit 12.

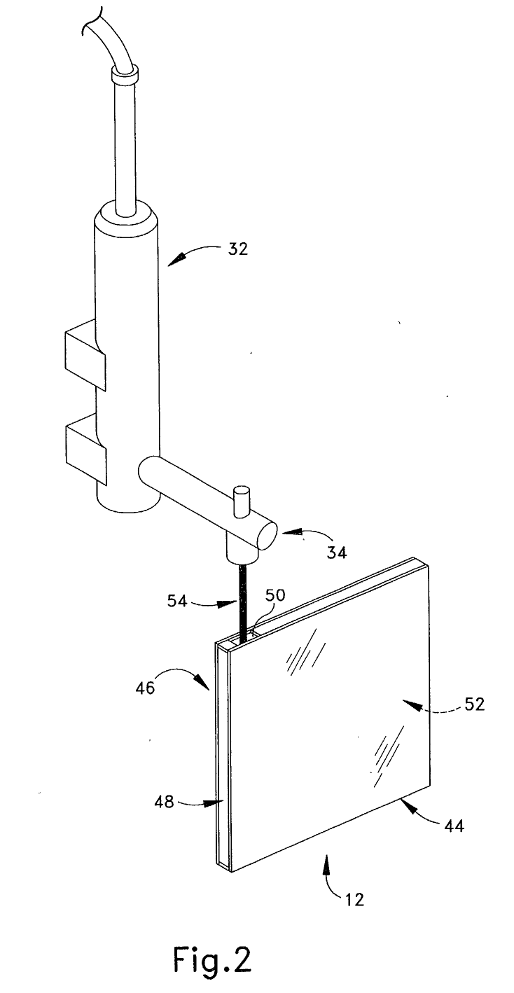

The multipane glass unit 12 will first be described. With reference to FIG. 2, the glass unit 12 includes at least two glass panes, e.g., a first pane of glass 44 and a second pane of glass 46, that are parallel to each other with a volume 52 (shown by the phantom arrow 52) therebetween. Located around the periphery of glass panes 44 and 46 is an adhesive/spacing material 48 that is used to connect the glass panes 44, 46 together and to maintain the glass panes 44, 46 in a spaced apart arrangement. The spacing material 48 may be any known or suitable adhesive or other material utilized for the construction of multipane glass units. At one upper corner of the glass unit 12, a section of the spacing material 48 is temporarily left out of the glass unit 12 to provide an opening 50 along the top edge of the glass unit 12. It is to be appreciated that the spacing material 48 that is left out to provide the opening 50 may be provided as a tag end that is later pressed into place or may be provided as an additional spacing material at a later step or may take any other practical form.

The first and second panes 44 and 46 and the spacing material 48 cooperate to create a volume 52 that is bounded within the glass unit 12. The opening 50 opens into the volume 52.

It is to be appreciated that certain modifications may be made to the glass unit 12 without departing from the intention of the present invention. For example, the glass unit 12 may be made with more than two panes of glass. This and other variations are considered to be within the scope of the invention.

Turning now to a discussion of the apparatus 10, the apparatus 10 includes a framework 14 and a support structure 16. The support structure is adjacent to a bottom of the framework 14, and the framework 14 extends upwardly from the support structure. The support structure 16 may include a plurality of rollers 18 on which the glass unit 12 can be supported and moved.

On the framework 14, the apparatus 10 includes at least one backrest structure 22 against which the glass unit 12 rests. In one example, the framework 14 is configured at a slight backward angle such that the glass unit 12 naturally tilts backward and rests upon the backrest structure 22. The slight backward angle aids in guarding against the accidental tipping and subsequent breaking of the glass unit 12. Further, each backrest structure 22 may include roller members 19 that can permit easy movement of the glass unit along the backrest structure 22.

The size of the apparatus 10 (and thus the size of the framework 14, support structure 16 and the size and number of backrest structure 22) is related to the size of the glass unit 12 that can be dosed by the apparatus 10. It is to be appreciated that the glass unit 12 typically should fit within the confines of the support structure 16. Also, it is to be appreciated that the multipaned glass unit 12 should be adequately supported via the backrest structures 22.

According to an example embodiment of the present invention, the apparatus 10 includes an arrangement 26 for introducing liquefied gas into the volume 52 within the glass unit 12. Specifically, the arrangement 26 delivers a liquefied gas into the volume 52 within the glass unit 12.

The gas of the liquefied gas may be any gas that has useful properties when placed within the volume 52 of the glass unit 12. Such useful properties include low conductance of heat, absorption and/or low conductance of certain portions of the light spectrum, low conductance of sound, etc. Examples of gasses with such useful properties include, but are not limited to, fluorocarbon gasses and noble gasses. Specific examples include, but are not limited to, nitrogen, argon, krypton and xenon. Also, any combination or mixture of such gasses is also possible. Regardless of the composition of the gas, the gas is delivered in a liquid state.

Returning to the arrangement 26, the arrangement 26 includes a supply tank 28 that contains the liquefied gas. The tank 28 is connected via a suitable tube 30 to a delivery head 32. The construction of the tube 30 may take any suitable form. For example, the delivery tube 26 may be insulated and may be contained within an evacuated tube to prevent frost or ice buildup. Also, the delivery tube 26 may be of any suitable length and may be coiled to permit ease of relative movement between the tank 28 and the delivery head 32.

Turning to the delivery head 32, in one example, the delivery head includes a small reservoir area. Typically, the reservoir area within the delivery head 32 is much smaller compared to the volume of the tank 28. Also, the delivery head may have a suitable heater or cooler or the like to maintain a certain temperature within one or more portions of the delivery head 32. Suitable pressure regulation components may also be provided in connection with the tank 28, the delivery tube 30 and the delivery head 32.

Within the delivery head 32 is provided a delivery device 34. In one example, the delivery device 34 includes a servo valve that may be controlled electrically. When the servo valve is closed, liquefied gas does not flow from the delivery device 34. When the servo valve is opened, a stream of liquefied gas is discharged from the delivery device 34. In one example, the stream of liquefied gas is delivered at a pressure of approximately 17 lbs/square inch. Of course, it is to be appreciated that other parameters and configurations may be employed to deliver the liquefied gas.

The framework 14 includes a tower 36 located on one side (e.g., a left side) of the framework. On the tower 36 is mounted a vertical track device 38. The delivery head 32 is movable in a vertical direction along the vertical track 38. The mechanism for moving the delivery head 32 along the vertical track 38 may be of any suitable structure and configuration. In one example, a counter balance arrangement is included such that the delivery head 32 is at a generally neutral balanced, or even a negative, weight on the vertical track 38. Also, in one example, the movement of the delivery head 32 along the vertical track 38 may be performed by a hydraulic or pneumatic arrangement. Further, in another example, the delivery head 32 may be manually moved along the vertical track 38.

In another example, the movement of the delivery head 32 may be controlled by a control unit 40. The possibility of the control unit 40 controlling the movement is indicated via the connection 42 (dash line) in FIG. 1. Suitable structure may be employed to aid the controlled movement. Examples of such structure include, but are not limited to, sensors for proximity and the like. It is understood that the present invention contemplates other arrangements for moving the delivery head 32 and is not intended to be limited to the examples presented herein.

The movement of the delivery head 32 along the vertical track 38 is such that the delivery head 34 is moved adjacent to an upper edge of the glass unit 12. In one example, the delivery head 34 does not contact the glass unit 12. In another example, the delivery head 32 nears or penetrates the opening 50 in the upper edge of the glass unit 12. As best seen in FIG. 2, the delivery device 34 is located on the delivery head 32, such that the delivery device is positionable adjacent to the upper edge of the glass unit 12.

As seen in FIG. 2, the delivery device 34 introduces a stream of liquefied gas 54 into the volume 52 of the glass unit 12. The liquefied gas 54 is directed toward the bottom of the volume 52 within the glass unit 12. The direction of the stream of liquefied gas 54 into the volume 52 may be at any angle (e.g., directly down or at an angle to the vertical direction). Because the liquefied gas 54 is much heavier than the air that initially occupies the volume 52, the liquefied gas 54 inherently arrives at the bottom of the glass unit 12.

The liquefied gas 54 quickly begins transforming from a liquid state to a gaseous state. This can be described as the liquefied gas 54 boiling. The boiling of the liquefied gas 54 typically occurs at normal ambient room temperatures. This is due in part to the physical properties of the gas. Also, this may be due in part to the fact that the gas is liquefied due to pressure within the tank 28 (FIG. 1). As the gas transforms to the gaseous state, the gas continues to pool or maintain it's position toward the bottom of the volume 52 within the glass unit 12. This is due in part to the fact that the gas is heavier than the ambient air. As the liquid gas 54 continues to transform to the gaseous state, the volume of the gaseous state gas continues to increase. Accordingly, the gaseous gas forces the air out of the volume 52 within the glass unit 12. The air is purged from the glass unit 12 via the same opening 50 that is used to introduce the stream of liquefied gas 54. Of course, it is to be appreciated that other, different and/or additional openings may be used to introduce the liquid stream or purge the ambient air.

It is to be noted that a relatively small volume of liquefied gas need be delivered into the volume 52 because the volume of liquefied gas will provide a relatively large volume of gaseous state gas. Also, it is to be noted that as the gas transforms from the liquefied state to the gaseous state, the purging of ambient air is relatively expedient. Thus according to the invention, glass units may be dosed with liquefied gas at a relatively rapid rate that allows the dosing to occur in real time within a relatively high speed assembly line that manufactures glass units for windows or the like.

It is to be appreciated that any suitable amount of liquid gas 54 may be introduced into the volume 52 of the glass unit 12. The suitable amount depends on several factors. The factors may include the desired purity of the resulting gas within the volume 52. For example, it may be within manufacturer tolerance limits to permit a certain amount of ambient air to remain within the space volume 52 of the glass unit 12.

Another point of consideration with regard to volume of liquefied gas 54 to introduce into the space volume 52 is the size of the volume 52 within the glass unit 12. Volume size depends on the dimensional parameters of the glass unit 12. These parameters include the height of the glass unit 12, the width of the glass unit 12, and the thickness of the glass unit 12. These three-dimensional parameters can be utilized to determine a precise dosage volume of liquefied gas to introduce into the space volume 52 to achieve desired gaseous results. As such, in accordance with another aspect of the present invention, the apparatus 10 includes components, structures, and mechanisms to determine the volume of the space volume 52 within the glass unit 12, a discussion of which will follow.

In order to determine the height of the glass unit 12, the arrangement for moving the delivery head 32 along the vertical track 38 may also be configured as a linear measurement device 70. The linear measurement device 70 is calibrated such that when the delivery device 34 is in close proximity to the opening 50 in the glass unit 12, the linear measurement device can provide a measurement value indicative of the height of the glass unit 12. The linear measurement device 70 may have any suitable configuration. In one example, the linear measurement device includes an arrangement of magnetic sensory members located along the vertical extent of the vertical track 38. According to this example, a sensor arrangement that travels with the delivery head perceives the magnetic elements that extend along the vertical track 38 and provides a height measurement to the control unit 40.

It is to be appreciated that any suitable construction may be provided for the linear measurement device 70. In view of the fact that the delivery head 32 travels down to close proximity with the upper edge of the glass unit 12, the movement of the delivery head provides for an expedient way to measure the vertical height of the glass unit 12. However, it should be appreciated that the height may be measured by some other arrangement not affiliated with the movement of the delivery head 32, such as vertical optical sensor 80. According to the vertical optical sensor 80 example embodiment, the vertical sensor 80 may sense the vertical dimensional parameters of the glass unit 12 and communicate this information to the control unit 40. The vertical sensor 80 may be mechanically coupled to a member 105. When so coupled, the vertical sensor 80 can move vertically along member 105. The vertical sensor 80 may be controlled by the control unit 40, as indicated by communication arrangement 43. Alternatively, the vertical sensor 80 may be controlled by other suitable device. The vertical sensor 80 may be calibrated so that the distance traveled by the sensor 80 from the bottom of the glass unit 12 to the top thereof will be translated into a height measurement. This height measurement in turn is communicated to the control unit 40 via communication arrangement 43.

In order to measure the width of the glass unit 12, the apparatus includes a horizontal distance measurement arrangement. In one example, the arrangement includes an arrangement of optical sensors that detect left and right edges of the glass unit 12. The distance between the detected left and right edges of the glass unit 12 is taken as the width of the glass unit. The horizontal distance measurement arrangement can be operatively connected to the control unit 40.

It is to be appreciated that various other constructions and arrangements can be utilized to measure the width of the glass unit 12. For example, measurement of the glass unit 12 may occur during rolling of the glass unit along the rollers 18 on the support structure 16. One or more sensors may be utilized to sense passage of the edges (left and right) of the glass unit 12 during such movement of the glass unit. The rolling movement between the detection of the edges is then utilized within calculation to determine the width of the glass unit 12. As another example, the apparatus may include width optical sensor 83. The width sensor 83 can operate in a similar manner to the vertical sensor 80 by sensing the width dimensional parameter of the glass unit 12 and communicate this information to the control unit 40. The width sensor 83 may be mechanically coupled to a member 107. When so coupled, the sensor 83 can move vertically along member 107. The width sensor 83 may be controlled by the control unit 40, as indicated by communication arrangement 45. The sensor 83 may be calibrated so that the distance traveled by the sensor 83 from the bottom of the glass unit 12 to the top thereof will be translated into a height measurement. This height measurement in turn is communicated to the control unit 40 through communication arrangement 45.

A thickness measurement arrangement 85 is provided to determine an overall thickness of the glass unit 12. In the illustrated example, the thickness measurement arrangement 85 includes a movable caliber arrangement that engages the front and back surfaces of the glass unit 12. The output of the arrangement 85 is indicative of the thickness. The output of the thickness measurement arrangement 85 is operatively connected to the control unit 40 as indicated by the dashed line 47.

It is to be appreciated that another type of thickness measuring arrangement may be utilized. For example, optical sensors or the like could be utilized to determine width.

Within the control unit 40, the overall thickness is processed to determine a thickness of the space volume 52 within the glass unit 12. Specifically, thickness of the first and second glass panes 44 and 46 are subtracted from the overall thickness measured via the thickness measurement arrangement 85. The glass thickness is easily measured separately and/or is provided via operator input to the control unit. It is to be appreciated that the thickness measurement arrangement 85 could be configured differently such that only the thickness of the space volume 52 is measured.

Within the control unit 40, the height, width, and thickness (corrected to subtract glass thickness) are utilized to calculate the volume of the space defined as volume 52 within the glass unit 12. The control unit 40 then uses this calculated volume to determine a volume of liquefied gas to be introduced into the volume 52 to achieve the desired gaseous state result.

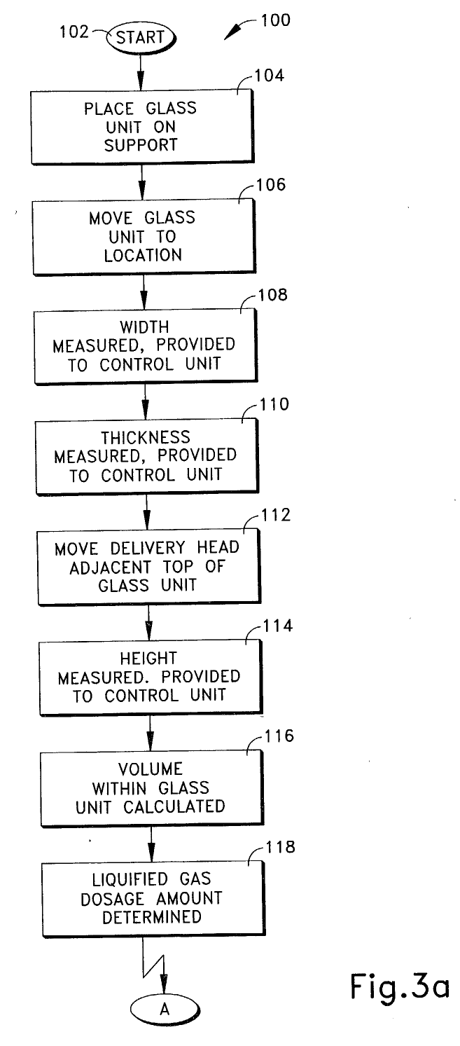

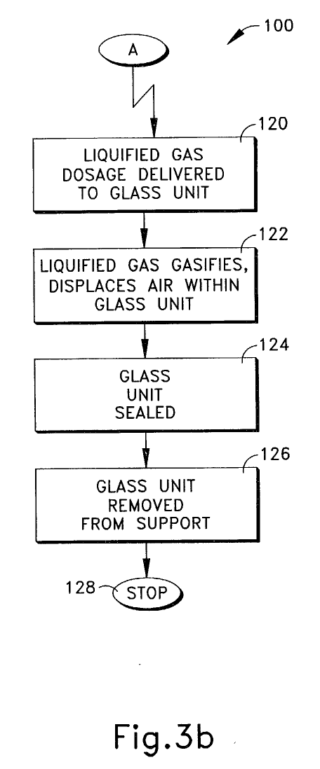

An example of a process 100 in accordance with the present invention is shown within FIGS. 3a and 3b. The process 100 is initiated at step 102 and proceeds to step 104. At step 104, the glass unit 12 is placed upon the support structure 16. At step 106, the glass unit 12 is moved (i.e., to the left) into a position at which it will receive its dosage of liquefied gas.

At step 108, the width is measured and the width information is provided to the control unit 40. Again, in one example, the width measurement is obtained via optical sensors, however other width measuring structure may be utilized, such as width optical sensor 83. At step 110, the thickness is measured and the thickness is provided to the control unit 40. In the example, the width is measured via a caliber type sensor system, however, it is understood that other thickness measuring structure could be utilized, such as thickness measurement arrangement 85.

At step 112, the delivery head 32 is moved downward such that the delivery device 34 is, for example, adjacent and spaced slightly from the top edge of the glass unit 12. At step 114, the height is measured and the information is provided to the control unit 40. The height measurement is accomplished during movement of the control head 32. It is to be appreciated that a different structure may be used to obtain the height measurement, as described above, such as by vertical optical sensor 80. Also, it is to be appreciated that the overall sequence of measuring may occur in a different order or may partially occur simultaneously.

With the dimensional parameters provided to the control unit 40, the control unit, at step 116, calculates the volume of the volume 52 within the glass unit 12. It is to be appreciated that other information (e.g., inputted of measured glass thickness) may be utilized within the calculation. At step 118, the dosage amount of the liquefied gas is determined based upon the volume 52 within the glass unit 12.

With reference to FIG. 3b, at step 120, the determined liquefied gas dosage 54 is delivered into the glass unit 12 by the delivery head 32 via the opening 50. At step 122, the liquefied gas gasifies and displaces the air from within the glass unit 12. At step 124, the glass unit 12 is sealed at the opening 50. The glass unit 12 is removed from the support 16 at step 126. The process 100 terminates at step 128.

From the above description of the invention, those skilled in the art will perceive improvements, changes and modifications. Such improvements, changes and modifications within the skill of the art are intended to be covered by the appended claims.

What is claimed is:

1. An apparatus comprising:
a liquid dosing unit that introduces a liquefied gas into a volume of a multipane glass unit, wherein the multipane glass unit is defined by one or more dimensional parameters.

2. The apparatus of claim 1, further comprising one or more measuring devices that measure the dimensional parameters of the multipane glass unit.

3. The apparatus of claim 2, further comprising a control unit that is operably connected to the measuring devices.

4. The apparatus of claim 3, wherein the measuring devices transmit the measurements of the dimensional parameters.

5. The apparatus of claim 4, wherein the control unit determines an amount of liquefied gas to introduce into the volume of the multipane glass unit based on the measurements of the dimensional parameters.

6. The apparatus of claim 5, wherein the control unit directs the liquid dosing unit to introduce the amount of liquefied gas into the volume of the multipane glass unit.
